(19) United States
(12) Patent Application Publication
(10) Pub. No.: US 2007/0231234 A1
(43) Pub. Date: Oct. 4, 2007

(54) Microwave assisted rapid gel combustion technique for producing ultrafine complex oxides and ceramic composites powders

(75) Inventors: Bhuvaragasamy G. Ravi, Port Jefferson Station, NY (US); Sanjay Sampath, Setauket, NY (US)

Correspondence Address: F. CHAU & ASSOCIATES, LLC, 130 WOODBURY ROAD, WOODBURY, NY, 11797, US

(73) Assignee: Research Foundation of the State University of New York

(21) Appl. No.: 11/397,168

(22) Filed: Apr. 4, 2006

(51) Int. Cl. C01F 17/00

(52) U.S. Cl. 423/263

(57) ABSTRACT

A method for producing oxide particles includes providing a metal ion-polymer complex, and generating microwave irradiation to heat the metal ion-polymer complex to decompose the precursor-polymer complex to yield the oxide particles.

The U.S. Government has a paid-up license in this invention and the right in limited circumstances to require the patent owner to license others on reasonable terms as provided for by the terms of grant no. DMR0080021, awarded by the National Science Foundation.

### BACKGROUND OF THE INVENTION

1. Technical Field

The present invention relates generally to ceramic oxide nanoparticles and, more particularly, to a microwave heating based method of producing compositionally uniform, spherical, high purity oxide nanoparticles.

2. Discussion of Related Art

Powders are used in numerous applications. Finely divided oxide powders are useful in the manufacture of coating compositions, complex shaped and fine-grained ceramics, cermets, and the like. They are the building blocks of electronic, telecommunication, electrical, magnetic, structural, optical, biomedical, chemical, thermal, and consumer goods. On-going market demand for smaller, faster, superior and more portable products has resulted in miniaturization of numerous devices. This, in turn, has demanded miniaturization of the building blocks, including powders. Sub-micron and nanoscale (or ultrafine, nanosize) powders, with a size 10 to 100 times smaller than conventional micron size powders, enable quality improvement and differentiation of product characteristics at scales currently unachievable by commercially available micron-sized powders. Nanopowders, therefore, represent an opportunity for design, development and commercialization of a wide range of devices and products for various applications. Furthermore, since they represent a whole new family of material precursors where conventional coarse-grain physiochemical mechanisms are not applicable, these materials offer unique combinations of properties that can enable novel and multifunctional components of unmatched performance.

Higher purity materials in the form of crystals, bulk materials, fibers, coatings and films are needed in functional applications. It is expected that the purity requirements for electronic and magnetic applications will increase even further. Hence simple and complex oxide powders are desired in greater and greater purity. Impurities cause failures or defects in electronic and other applications. Higher purity chemicals and materials offer a means of greater product reliability and performance. They also offer means to extend the life of products. For example, luminescence coatings prepared from high purity ultrafine powders offer longer life and superior performance. Existing applications that use commercially available low purity chemicals and materials may all benefit from higher purity chemicals and materials. Since many chemicals and materials are used in the form of powders at some stage, high purity powders are needed and are expected to be needed in the future.

Typically the starting materials in the oxide form are mixed together in the desired proportions by dry or wet ball milling. After the milling the material is heated to 500C.-800.C., and the resulting material is crushed and milled again. This process can be further repeated to obtain additional homogeneity. These methods are expensive, slow, low volume, and difficult when purities greater than 99.99% are desired. This is one reason why powders with purity greater than 99.9% often enjoy price premiums that are 100 fold higher than readily available low purity powders (95 to 98%).

A variety of soft-chemical routes have been developed to circumvent the conventional ceramic route synthetic difficulties to prepare fine powders [REF]. One procedure involves the decomposition method, in which the starting materials are mixed by milling in the salt form instead of the oxide form, and then the salts are converted to the oxides by thermal decomposition in air. Another procedure involves the precipitation method, which has been utilized in an attempt to avoid the lengthy milling process of the oxide and decomposition methods. The objective is to precipitate from a solution the required materials simultaneously in either a hydroxide or oxalate form to yield a precipitate containing the required metal hydroxides or metal oxalates in the correct proportions intimately mixed.

The above described oxide, decomposition, and precipitation methods involve various disadvantages. In the oxide and decomposition methods the lengthy ball milling that is required is a disadvantage. Even with extended ball milling there is room for much improvement in the homogeneity of the resulting mixture. The precipitation methods directionally improve mixture homogeneity, but entail other disadvantages. For example, when a strong base such as sodium hydroxide is used to cause precipitation, the cation must be removed from the resulting mixture to purify it, and this can present a difficult purification problem. Further precipitation methods involve, in general, complicated or delicate steps requiring for example the precise control of pH, precipitation, centrifugation, refluxing for a long time etc., to achieve the required stochiometry.

Therefore, a need exists for a method of preparing a powder.

### SUMMARY OF INVENTION

According to an embodiment of the present disclosure, a method for producing oxide particles includes providing a metal ion-polymer complex, and generating microwave irradiation to heat the metal ion-polymer complex to decompose the precursor-polymer complex to yield the oxide particles.

### BRIEF DESCRIPTION OF THE FIGURES

Preferred embodiments of the present invention will be described below in more detail, with reference to the accompanying drawing:

FIG. 1 is a schematic diagram showing a method for the formation of crystalline powders according to an embodiment of the present disclosure.

### DETAILED DESCRIPTION OF PREFERRED EMBODIMENTS

According to an embodiment of the present disclosure, microwave energy is implemented to process various kinds of materials. Microwave heating of materials is fundamentally different from conventional radiation-conduction-convection heating. In the microwave process, the heat is generated internally within the material instead of originating from external heating sources. Microwave heating is a sensitive function of the material being processed.

Microwaves are electromagnetic radiation with wavelengths ranging from 1 mm to 1 m in free space and frequency between approximately 300 GHz to 300 MHz, respectively. Microwaves at about the 2.45 GHz frequency are used. While ceramics and certain polymers and elastomers absorb microwave energy partly at low temperatures and increasingly at higher temperatures.

Microwave pyrolysis/decomposition is self-regulating; microwave absorption characteristics change once the susceptor is chemically altered. Therefore, products having uniform particle size distribution can be expected to form. Further, microwave heating can be used in the preparation of ceramic composites because of the differential susceptibilities (and hence the heating rates) of the different precursors used in their preparations to generate unique morphologies.

Example: preparation of YAG, YIG, YAG-YIG

The chemicals used for synthesis of Y₃Al₅O₁₂ (YAG) were Y(NO₃)₃.6H₂O (99.9%) and Al(NO₃)₃.8H₂O (99.9%) The chemicals used for synthesis of europium/chromium doped Y₃Al₅O₁₂ were Y(NO₃)₃.6H₂O (99.9%), Al(NO₃)₃.8H₂O (99.9%) and europium/chromium nitrate. The chemicals used to synthesis Y₃Fe₅O₁₂ (YIG) powders were Y(NO₃)₃.6H₂O (99.9%), Fe(NO₃)₃.8H₂O (99.9%), The chemicals used to synthesis YFe₅₋ₓAlₓO₁₂ powders were Y(NO₃)₃.6H₂O (99.9%), Fe(NO₃)₃.8H₂O (99.9%), Al(NO₃)₃.8H₂O (99.9%). An appropriate quantity of fuel (e.g., citric acid monohydrate (99.5%,)/ethylene glycol/glycine) was added with oxidant (e.g., nitrate mixtures) in de-ionized water. The material synthesis for this study included preparation of precursor liquid and pyrolytic decomposition of precursor liquid to form crystalline powders using microwaves.

The polymeric precursor liquids were prepared by mixing 0.1 to 1.0 M solutions of nitrates (oxidant), in appropriate quantities, in separate glass beakers. Citric acid and or ethylene glycol/glycine (fuel) with a fuel:oxidant molar ratio of 0 to 1 in water was added to the above mixture while stirring. An appropriate molar ratio of fuel:oxidant induces a self-propagating and controlled ignition in a ceramic oxide system.

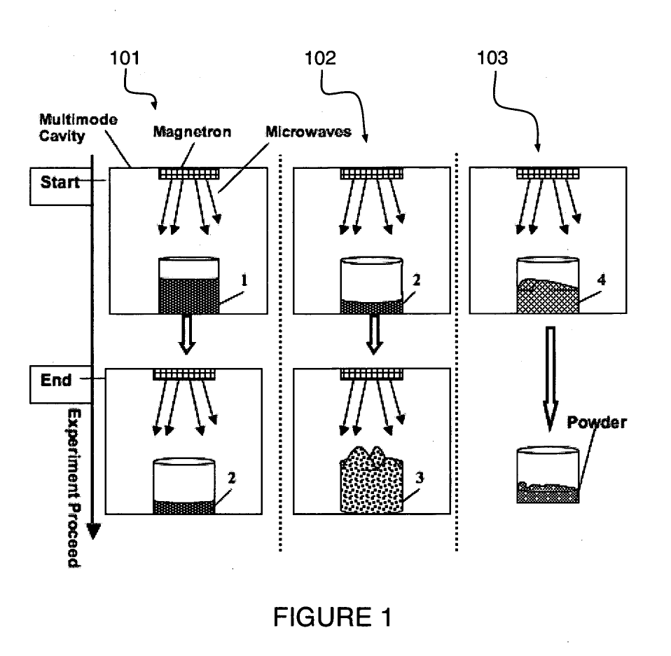

Referring to FIG. 1, the pyrolytic decomposition of polymeric precursor liquid (1) included continuously stirring the mixed solution while heating in a microwave oven operating at the lowest power settings, keeping the solution temperature at about 100° C., to remove about 80% by volume of its water (see section 101). At section 102, a microwave oven of multimode cavity operating at a frequency of about 2.45 GHz and a variable output power of about 750 to 1000 W was used for pyrolytic decomposition. The condensed precursor liquid (2) in a glass beaker/aluminum oxide crucible was placed inside microwave and decomposed by microwave irradiation in the oven for brief periods. Within about 3 minutes of heating we observed a rapid increase in the viscosity of precursors leading to formation of dry and crispy foam-like product (3) in the beaker. Further exposure to microwaves did not cause any change in the foam-like products. The oven was switched off, the foam-like products were removed from beaker and crushed using a pestle and mortar. At section 103, the crushed powder (4) was decomposed for second time in microwaves to yield crystalline products in about 3 to 5 min. The maximum temperature measured at the end of microwave assisted combustion reaction was never exceeded about 200° C. The entire microwave operation was performed inside a fume hood and provisions were made in the microwave oven to remove the hot gases released during combustion.

Thermal analysis:

Differential thermal analysis (DTA) coupled with thermogravimetry (TG) were used to analyze the decomposition rate, and crystallization temperature of the dried gel, before combustion, and microwave combustion formed powders. The results revealed that microwave combustion formed powers do not need higher temperature calcinations as the crystalline product formed during combustion itself.

Powder X-ray diffraction (XRD):

Powder XRD analysis reveals rapid microwave assisted citrate-nitrate combustion technique adopted in this work resulted in crystalline products from amorphous precursors. The XRD findings also revealed that microwave combustion resulted in single phase in a multi component oxides and no unwanted additional phase in a composite. The average crystallite size of powder, calculated using XRD data was 20-35 nm.

Scanning electron Microscopy (SEM):

The SEM micrographs reveal microwave assisted gel pyrolysis/combustion ultimately resulted into nano-crystalline particles with particle sizes of less than 100 nm. The self-regulating nature of microwave absorption characteristic preserved the nano-crystalline particles formed in the combustion reaction. Once the product is formed it may no longer susceptible to microwaves and thus it may not be heated up further in microwaves.

According to an embodiment of the present disclosure, a rapid microwave assisted citrate-nitrate gel combustion method is used to prepare oxide and composite nanoparticles. Combustion in microwaves takes place in a controlled manner as the reaction stops once the power is turned off. Further the reaction proceeds without any flames. Occasional micro-fire spots have been observed which subsequently self-extinguished. Selective microwave absorption of the oxidant (e.g., nitrates) and fuel (e.g., citric acid/glycine/ethylene glycol) and self-regulating characteristic of microwaves, substantially prevent over-heating of the nanoparticles formed in the combustion reaction. Since microwave assisted pyrolytic decomposition occurs at relatively low temperatures and in extremely shorter time, this method can be used to produce multi functional oxide nanoparticles with unique properties.

According to an embodiment of the present disclosure, a method for producing oxide nanoparticles, comprises, generating a metal ion-polymer complex comprising inorganic/metalorganic precursor and polymers, which substantially avoids metal ion segregation, and generating microwave irradiation to heat sufficiently the precursor-polymer complex to relatively low temperature combustion where precursor-polymer complex decomposed to yield oxide nanopowders and nanocomposites.

According to an embodiment of the present disclosure a method for producing oxide micro and nanoparticles includes microwave assisted production of oxide, multioxide, composite powders having purity in excess of 99.9%, preferably 99.999%. Powders produced are of size less than 10 micron, less than about 1 micron, and less than about 100 nanometers. These methods can readily be used for producing such powders in high volume, low-cost, with reproducible quality. The powders are useful in various applications such as biomedical, sensor, electronic, electrical, photonic, thermal, piezo, magnetic, catalytic and electrochemical products.

Having described embodiments for a microwave heating based method of producing compositionally uniform, spherical, high purity oxide nanoparticles, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for producing oxide particles comprising:
providing a metal ion-polymer complex; and
generating microwave irradiation to heat the metal ion-polymer complex to decompose the precursor-polymer complex to yield the oxide particles.

2. The method of claim 1, wherein the metal ion-polymer complex comprises one of an inorganic and a metalorganic precursor.

3. The method of claim 1, wherein providing the metal ion-polymer complex further comprises:
preparing an oxidant solution; and
adding a fuel to the oxidant solution to achieve a ratio of fuel to oxidant for inducing a self-propagating and controlled ignition in a ceramic oxide system during the generation of the microwave irradiation.

4. The method of claim 3, wherein the oxidant solution includes nitrates.

5. The method of claim 3, wherein the fuel comprises at least one of Citric acid, Glycine, and Ethylene Glycol.

6. A method for producing oxide particles comprising:
preparing a polymeric precursor liquid;
performing a pyrolytic decomposition of the polymeric precursor liquid comprising,
preparing a condensed precursor liquid by stirring the polymeric precursor liquid while heating by microwave irradiation of a first power, and
decomposing the condensed precursor liquid by microwave irradiation of a second power, greater than the first power, forming a pyrolytically decomposed polymeric precursor product;
crushing the pyrolytically decomposed polymeric precursor product to form a crushed product; and
decomposing the crushed product by microwave irradiation to form the oxide particles.

7. The method for producing oxide particles of claim 6, wherein the mixed solution is to a temperature of about 100° C., to remove about 80% by volume of its water.

8. The method for producing oxide particles of claim 6, wherein the second power is about 750 to 1000 Watts at a frequency of about 2.45 gigahertz.

9. The method for producing oxide particles of claim 6, wherein decomposing the crushed product comprises heating the crushed product to a temperature less than about 200° C.

10. The method for producing oxide particles of claim 6, wherein providing the polymeric precursor liquid further comprises:
preparing an oxidant solution; and
adding a fuel to the oxidant solution to achieve a ratio of fuel to oxidant for inducing a self-propagating and controlled ignition in a ceramic oxide system during the generation of the microwave irradiation.

11. The method for producing oxide particles of claim 10, wherein the oxidant solution includes nitrates.

12. The method for producing oxide particles of claim 10, wherein the fuel comprises at least one of Citric acid, Glycine, and Ethylene Glycol.
